(19) United States
(12) Patent Application Publication
(10) Pub. No.: US 2005/0284994 A1
(43) Pub. Date: Dec. 29, 2005

(54) Pivotal computer bracket

(75) Inventor: Yun-Chung Chang, Hsin Tien City (TW)

Correspondence Address: NIKOLAI & MERSEREAU, P.A., 900 SECOND AVENUE SOUTH, SUITE 820, MINNEAPOLIS, MN, 55402, US

(73) Assignee: Biostar Systems Co., Ltd., Hsin Tien City (TW)

(21) Appl. No.: 10/875,109

(22) Filed: Jun. 23, 2004

(51) Int. Cl. F16M 11/00

(52) U.S. Cl. 248/220.21

(57) ABSTRACT

A computer bracket includes an upper bracket and a lower bracket selectively and pivotally connected to the upper bracket to allow the upper bracket to be pivotal relative to the lower bracket. A lock device is provided to secure position of the upper bracket relative to the lower bracket.

### BACKGROUND OF THE INVENTION

1. Field of the Invention

The present invention relates to a computer bracket, and more particularly to a pivotal computer bracket to allow the operator to easily have access to computer accessories received in the bracket.

2. Description of Related Art

Normally a conventional computer bracket is a hollow rectangular casing to receive therein computer accessories, such as a hard drive, a floppy diskette reader, etc. When any one of the computer accessories is out of order, the operator has to maneuver the auxiliary tools for repairing or replacing the malfunctioned accessory in a limited space. Besides, the wiring inside bracket is annoying especially when the available space for working is so limited. Therefore, the conventional computer bracket is not user-friendly to proceed any required work.

To overcome the shortcomings, the present invention tends to provide an improved computer bracket to mitigate the aforementioned problems.

### SUMMARY OF THE INVENTION

The primary objective of the present invention is to provide an improved computer bracket to allow the operator to easily have access to the computer accessories inside the bracket.

Another objective of the present invention is to provide a safety mechanism in the computer bracket to secure the bracket such that when the upper bracket is pivoted relative to the lower bracket, the operator is protected from injury that may otherwise occur by an accidental falling of the upper bracket relative to the lower bracket.

Still another objective of the present invention is to provide a lock device between the upper bracket and the lower bracket to secure the position of the upper bracket relative to the lower bracket.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the computer bracket of the present invention;

FIG. 2 is an exploded perspective view of the computer bracket of the present invention;

FIG. 3 is an exploded perspective view showing the respective engagement structure of the upper bracket and the lower bracket;

FIGS. 4 and 5 are schematic side plan views showing the status of the upper bracket relative to the lower bracket before and after a pivotal movement of the upper bracket relative to the lower bracket;

FIG. 6 is a perspective view showing the safety mechanism of the present invention between the upper bracket and the lower bracket;

FIG. 7 is a schematic perspective view showing the movement of the safety mechanism after the upper bracket is pivoted relative to the lower bracket;

FIG. 8 is an exploded perspective view showing that a lock device is arranged between the upper bracket and the lower bracket;

FIG. 9 is a perspective view showing the lock device in FIG. 8 is assembled so that the position of the upper bracket is secured relative to the lower bracket;

FIGS. 10 and 11 are schematic cross sectional views showing the status before and after the lock device is activated.

### DETAILED DESCRIPTION OF THE PREFERRED EMBODIMENT

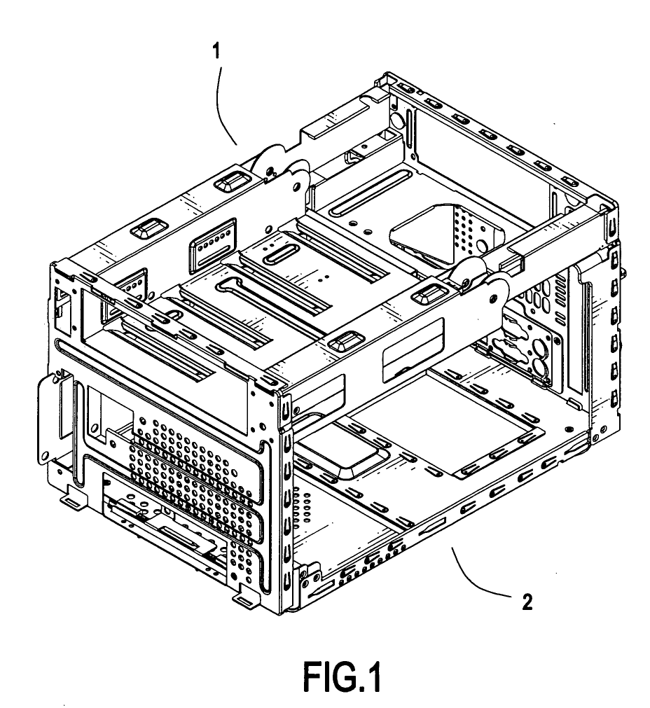

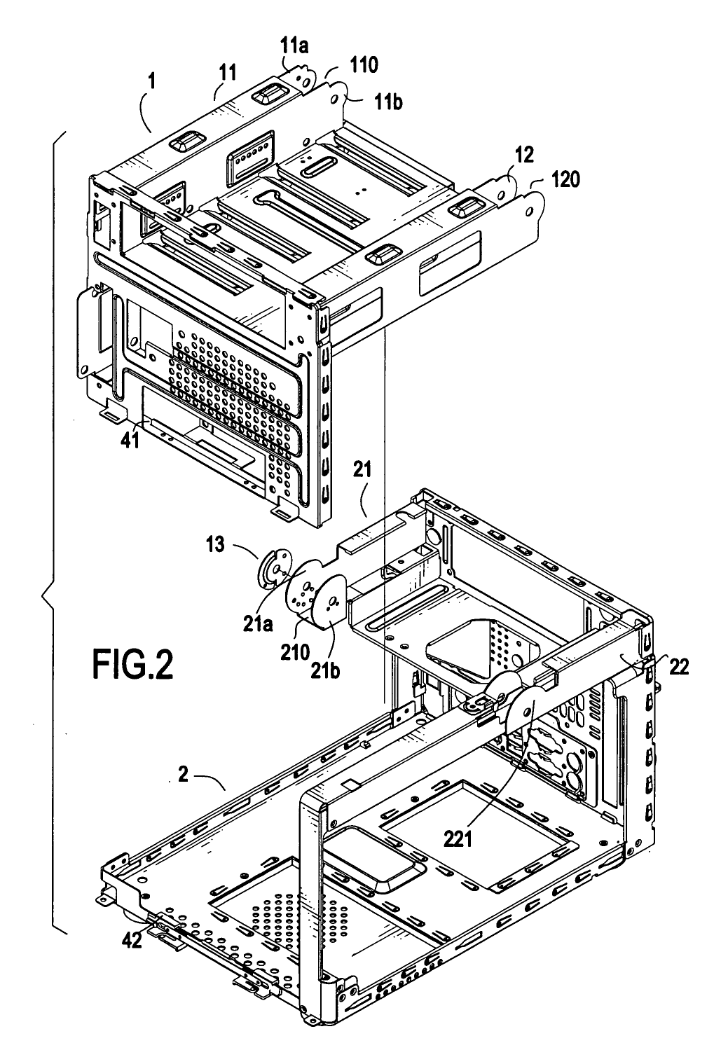

With reference to FIGS. 1 and 2, the computer bracket in accordance with the present invention has an upper bracket (1) and a lower bracket (2) pivotally connected to the upper bracket (1).

The upper bracket (1) has a substantially L-shaped cross section such that the upper bracket (1) has a first arm (11) and a second arm (12) extending in parallel to each other in an upper portion of the upper bracket (1). A first cutout (110) is defined in a central portion of the first arm (11) to thus divide the first arm (11) into an outer portion arm (11a) and an inner portion arm (11b). The second arm (12) has a passage (120) defined through a bottom face of the second arm (12).

The lower bracket (2) has a substantially L-shaped cross section, a third arm (21) corresponding to the first arm (11) and a fourth arm (22) extending in parallel with the third arm (21) and corresponding to the second arm (12). The third arm (21) has a second cutout (210) defined in a central portion of the third arm (21) to divide the third arm (21) into an outer plate (21a) to correspond to and engage with the outer portion arm (11a) and an inner plate (21b) to correspond to and engage with the inner portion arm (11b). The fourth arm (22) has a pair of ears (221) integrally extending outward from a top face of the fourth arm (22).

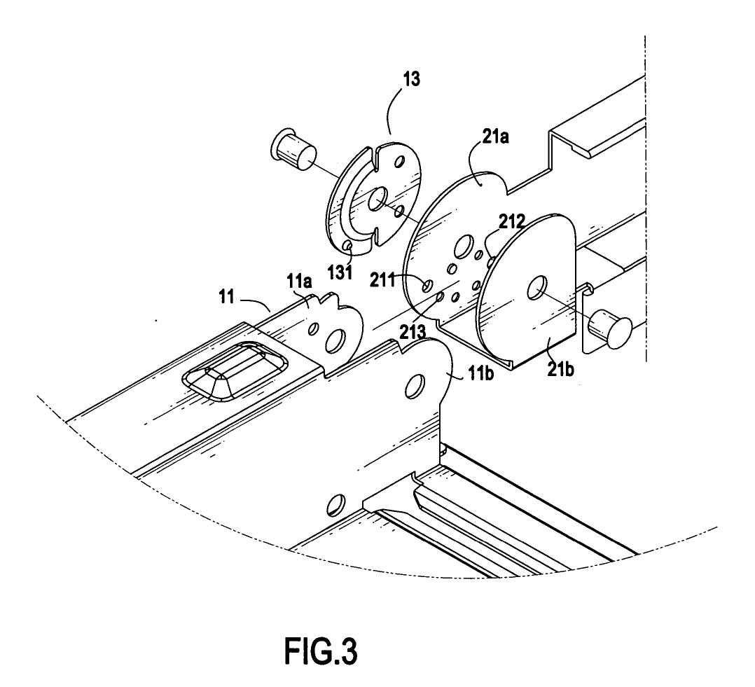

With reference to FIG. 3 and still taking FIG. 2 for reference, a disk (13) is sandwiched between the outer arm (11a) and the outer plate (21a) and has a boss (131) formed on an inner face of the disk (13) to respectively correspond to a first positioning hole (211), a second positioning hole (212) and through holes (213) defined between the first and second positioning holes (211, 212). That is, the boss (131) is able to be positioned at either one of the first or second positioning holes (211, 212) by passing the through holes (213). Therefore, when the upper bracket (1) is assembled with the lower bracket (2) by joining the first arm (11) and second arm (12) of the upper bracket (1) with the third arm (21) and the fourth arm (22) with rivet (not numbered), the disk (13) is sandwiched between the outer arm (11a) and the outer plate (21a) of the third arm (21). It is to be noted that the disk (13) is securely engaged with the outer arm (1 a) and is thus pivotal relative to the outer plate (21a). Because the distance between the outer and inner plates (21a, 21b) is shorter than a distance between the outer portion arm (11a) and the inner portion arm (11b), the inner portion arm (11b) is outside the inner plate (21b).

Further, due to the passage (120) of the second arm (12), the second arm (12) is able to receive therein the fourth arm (22) therein with the ears (221) extending upward for connection to a distal end of the second arm (12) by riveting. Therefore, after the upper bracket (1) is pivotally connected to the lower bracket (2), the upper bracket (1) is able to pivot relative the lower bracket (2).

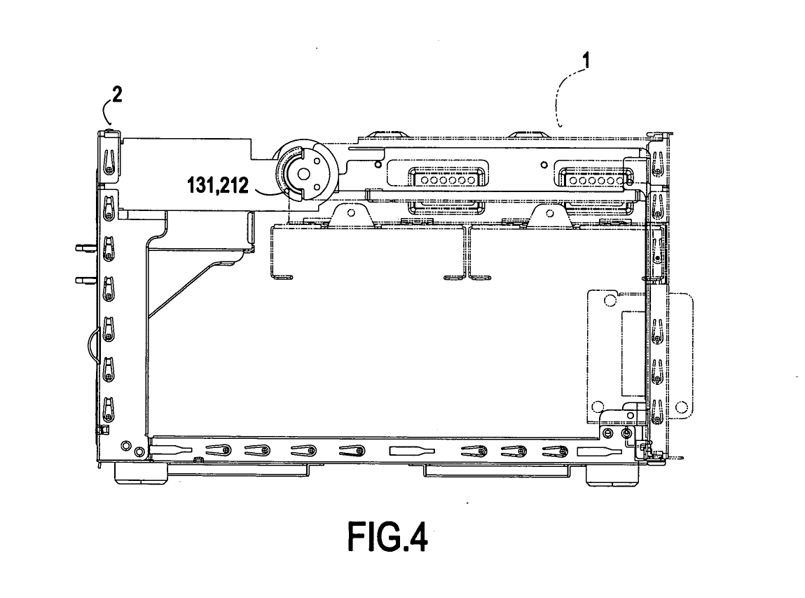

With reference to FIGS. 4 and 5, before the upper bracket (1) is pivoted relative to the lower bracket (2), the boss (131) of the disk (13) is located in the first positioning hole (211). After the upper bracket (1) is pivoted relative to the lower bracket (2), the boss (131) is located at the second positioning hole (212) to fix the position of the upper bracket (1) relative to the lower bracket (2).

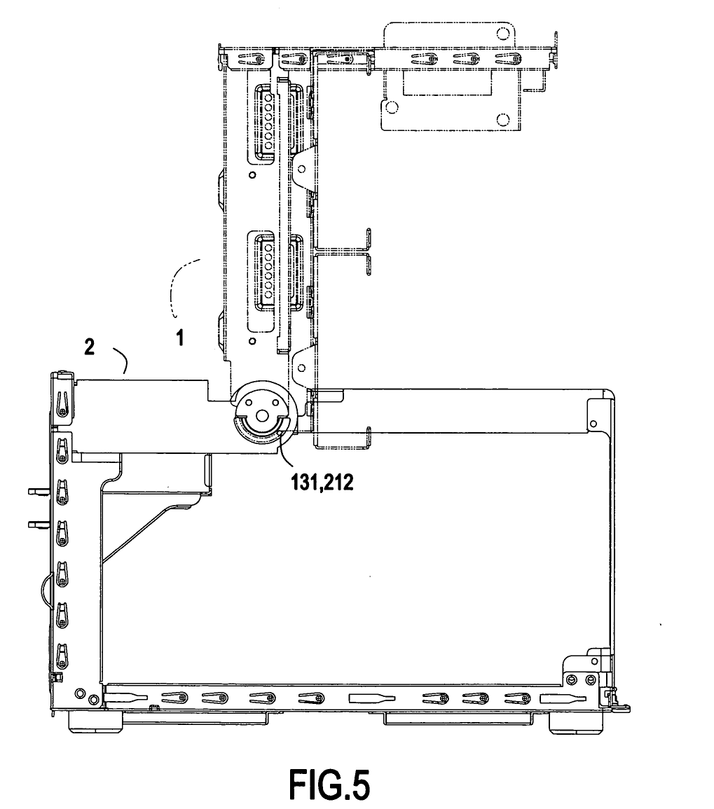

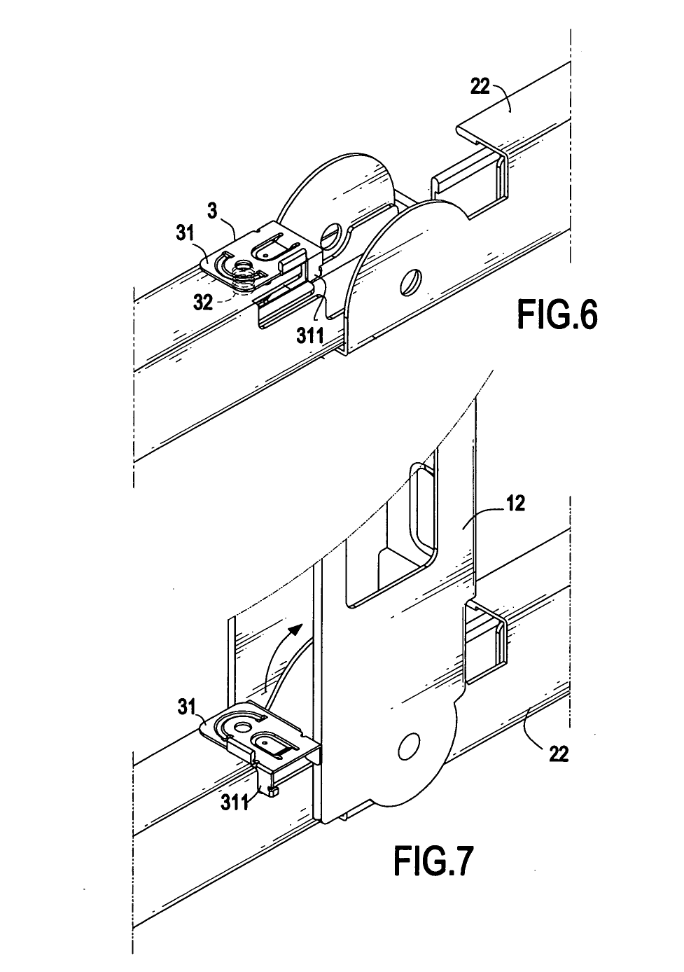

With reference to FIGS. 6 and 7, in order to secure the position of the upper bracket (1) relative to the lower bracket (2) especially after the upper bracket (1) is pivoted relative to the lower bracket (2), a safety mechanism is provided to stop the pivotal movement of the upper bracket (1). Preferably, the safety mechanism is composed of a safety plate (31) pivotally connected to a top face of the fourth arm (22) and a spring (32) having a first end securely connected to a face of the fourth arm (22) and a second end abutting a side face of an abutting arm (311) which is integrally formed with the safety plate (31). Therefore, when the second arm (12) is mounted on top of the fourth arm (22), the abutting arm (311) is stopped by a side face of the second arm (12) even when the spring (32) is urging against the abutting arm (311). However, after the second arm (12) is pivotally moved relative to the fourth arm (22), the safety plate (31) is pivoted by the spring (31) and thus the abutting arm (311) is located perpendicular relative to the second arm (12). Therefore, the pivotal movement of the second arm (12) is stopped by the safety mechanism of the present invention and the operator's safety is guarded.

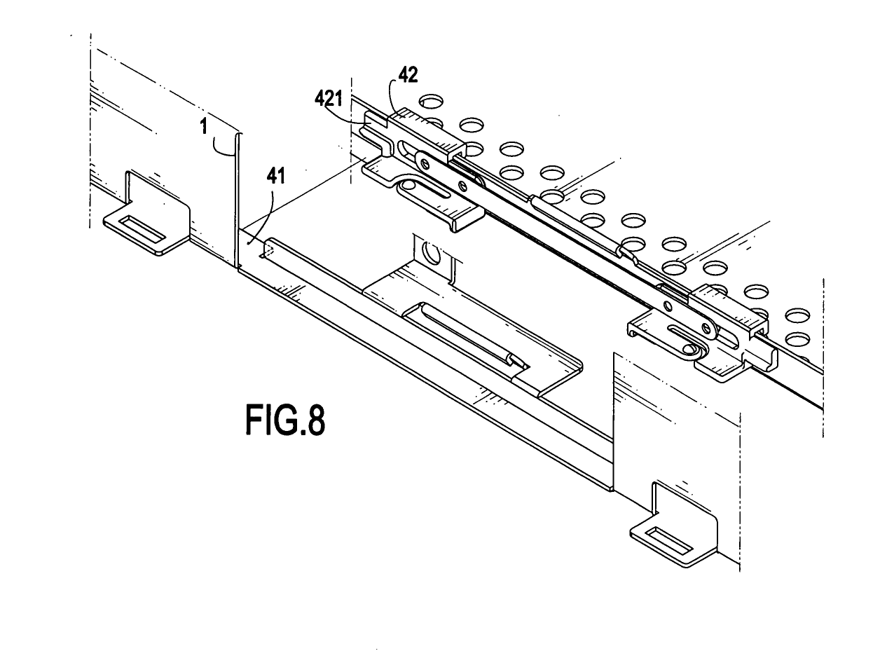

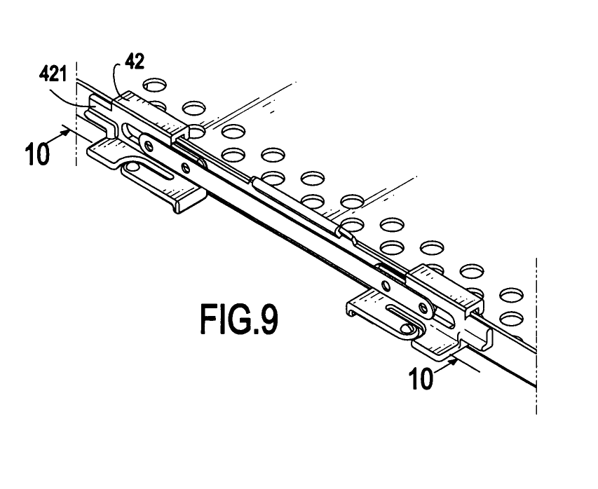

With reference to FIGS. 8, 9 and taking FIG. 2 for reference, it is noted that a lock device (4) is provided to secure the position of the upper bracket (1) relative to the lower bracket (2). The lock device (4) includes a pair of locking plates (41) integrally formed and extending from an inner face of the upper bracket (1) and a pair of sliding plates (42) slidably mounted on the lower bracket (2) to correspond to and engage with the locking plates (41). Each of the sliding plates (42) has a finger extending in opposite directions relative to each other.

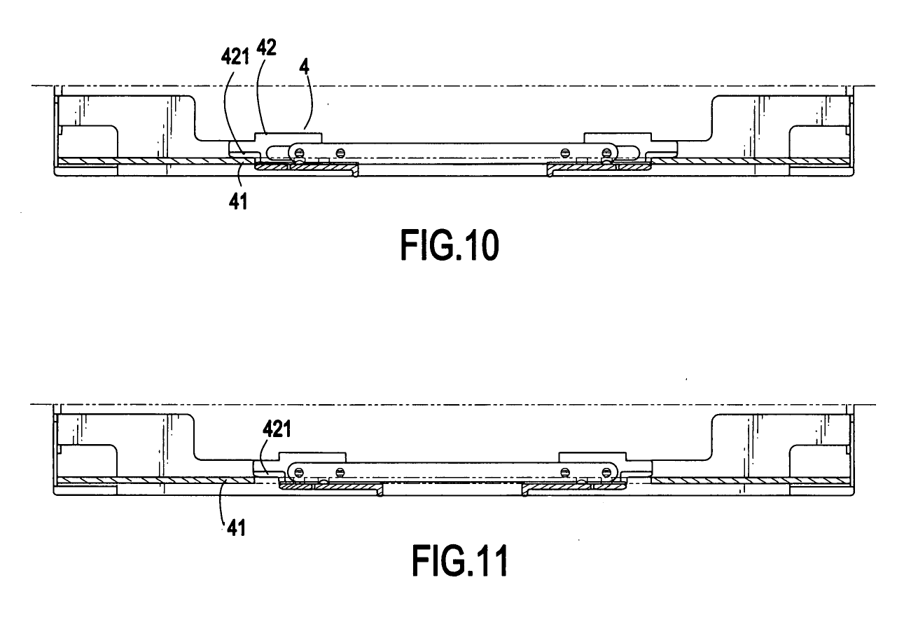

With reference to FIGS. 10 and 11, before the sliding plates (42) are moved along a peripheral side of the lower bracket (2), the upper bracket (10) is pivotal relative to the lower bracket (2). However, when the sliding plates (42) are moved to allow the fingers (421) to be on top of the locking plates (41), the pivotal movement of the upper bracket (1) is stopped and thus the upper bracket (1) is secured by the lower bracket (2).

From the description, it is noted that the operator is able to release the lock device (4) to allow the upper bracket (1) to be pivotal relative to the lower bracket (2) such that the operator is able to have easy access to the computer accessories to proceed maintenance or replacement work to the computer accessories.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A computer bracket comprising:
an upper bracket, wherein the upper bracket has a first arm and a second arm extending in parallel with the first arm;
a lower bracket selectively and pivotally connected to the upper bracket to allow the upper bracket to be pivotal relative to the lower bracket, wherein the lower bracket has a third arm corresponding to and pivotally connected with the first arm, and a fourth arm corresponding to and pivotally connected with the second arm;
a lock device to secure position of the upper bracket relative to the lower bracket; and
a safety mechanism to lock a position after the upper bracket is pivoted relative to the lower bracket when the lock device is released, wherein the safety mechanism comprises a safety plate pivotally mounted on the fourth arm and a spring having a first end securely mounted to a side face of the fourth arm and a second end abutting to a side face of the safety plate such that when the lock device is activated to have the fourth arm received in the second arm, the safety Plate is stopped by an inner side face of the second arm and when the lock device is released and the upper bracket is pivoted the safety plate is pushed by the spring to stop the upper bracket to return to the original position of the upper bracket.

2. (canceled)

3. The computer bracket as claimed in claim 1, wherein the first arm has a first cutout defined in a center of the first arm to divide the first arm into an outer portion arm and an inner portion arm, the second arm has a passage defined through a bottom face of the second arm, the third arm has a second cutout defined in a center of the third arm to divide the third arm into an outer plate to pivotally connect to the outer arm and an inner plate to pivotally connect to the inner arm.

4. The computer bracket as claimed in claim 3 further comprising a disk securely connected to the outer arm and pivotally connected to the inner plate.

5. The computer bracket as claimed in claim 4, wherein the disk has a boss formed on an inner face of the disk to correspond to a first positioning hole and a second positioning hole which are defined in the outer plate so that when the upper bracket is pivoted, the boss is movably and selectively received in the first and second positioning holes so as to secure position of the upper bracket relative to the lower bracket.

6-8. (canceled)

9. The computer bracket as claimed in claim 1, wherein the lock device comprises a pair of locking plates integrally formed with the upper bracket and a pair of sliding plates movably mounted on the lower bracket to be selectively located on top of the locking plates to stop pivotal movement of the upper bracket.

10. The computer bracket as claimed in claim 4, wherein the lock device comprises a pair of locking plates integrally formed with the upper bracket and a pair of sliding plates movably mounted on the lower bracket to be selectively located on top of the locking plates to stop pivotal movement of the upper bracket.

11. The computer bracket as claimed in claim 5, wherein the lock device comprises a pair of locking plates integrally formed with the upper bracket and a pair of sliding plates movably mounted on the lower bracket to be selectively located on top of the locking plates to stop pivotal movement of the upper bracket.

12-16. (canceled)
